(19) United States
(12) Patent Application Publication
(10) Pub. No.: US 2009/0155466 A1
(43) Pub. Date: Jun. 18, 2009

(54) ORGANIC MATERIAL LAYER FABRICATION METHOD

(75) Inventor: Shuenn-Jiun Tang, Zhubei City (TW)

Correspondence Address: PAI PATENT & TRADEMARK LAW FIRM, 1001 FOURTH AVENUE, SUITE 3200, SEATTLE, WA, 98154, US

(73) Assignee: RAYSTAR OPTRONICS, INC., Taichung (TW)

(21) Appl. No.: 12/057,630

(22) Filed: Mar. 28, 2008

(30) Foreign Application Priority Data
Dec. 12, 2007 (TW) 96147527

(51) Int. Cl. B05D 1/32; B05D 3/00; B05D 3/02

(52) U.S. Cl. 427/282; 427/350

(57) ABSTRACT

An organic material layer fabrication method includes the step of coating a surface of a substrate with an organic material that contains an organic solvent, and the step of lowering the pressure around the organic material to lower the solvent content of the organic material. By reducing pressure around the organic material to lower the solvent content of the organic material during the fabrication of the organic material layer, the invention eliminates material overflow, improves manufacturing quality, shortens the fabrication time, and reduces the manufacturing cost.

### BACKGROUND OF THE INVENTION

1. Field of the Invention

The present invention relates to OLED (Organic Light Emitting Diode) and more particularly to an organic material layer fabrication method for the production of an organic material layer for OLED.

2. Description of the Related Art

Because of the advantages of self-luminance, light-weight and thinness and wide operating temperature range, OLED (Organic Light Emitting Diode) has been regarded as an important type of flat-panel display.

An OLED is comprised of an ITO (Indium-Tin-Oxide) substrate, an organic material layer, and a cathode layer. The organic material layer for this purpose generally comprises an EML (Emitting Material Layer), an EIL (Electronic Inject Layer), an ETL (Electron Transport Layer), a HTL (Hole Transport Layer), and a HIL (Hole Inject Layer).

During fabrication of the aforesaid structure a semiconductor coating technique is employed to deposit every organic material sub-layer on the ITO substrate, and then the substrate is pre-baked to vaporize solvent content from the organic material, and then the organic material is baked and cured, and then the organic layer processing procedure is repeated again and again and the desired electrodes are made, and finally a packaging process is employed to complete the fabrication of the OLED. When making an OLED on the substrate, a mask having openings is arranged on the surface of the ITO substrate, and then an organic material is coated on the surface of the mask. As shown in FIG. 5, after the organic material 60 is filled in the openings 62 of the mask 61 to form a number of organic display units on the surface of the substrate 63, pre-baking, cure-baking and packaging steps are performed to finish the fabrication.

When the organic material is filled in the openings 62 of the mask 61, the organic material 60 may penetrate into the gap in between the mask 61 and the substrate 63 due to material flowability, causing an overflow of the organic material from the openings 62. When this happens, the organic material 60 will be bonded between the mask 61 and the substrate 63. Further, if the substrate 63 is moved due to impact or vibration during fabrication or upon removal of the mask 61 from the substrate 63, the bonding of the organic material 60 between the mask 61 and the substrate 63 will cause damage to the organic material 60 and affect the light emitting quality. Further, after the organic material is deposited on the substrate, a certain length of waiting time is necessary before the pre-baking, cure-baking and other processing processes are performed. Therefore, this fabrication method requires a relatively longer fabrication time, and the manufacturing cost is high.

### SUMMARY OF THE INVENTION

The present invention has been accomplished under the circumstances in view. It is therefore one object of the present invention to provide an organic material layer fabrication method which prevents organic material overflow during the fabrication, thereby improving the manufacturing quality.

It is another object of the present invention to provide an organic material layer fabrication method which shortens the fabrication time, thereby lowering the manufacturing cost.

To achieve these and other objects of the present invention, the organic material layer fabrication method comprises the steps of: (1) coating a solvent-containing organic material and (2) lowering the surrounding pressure around the organic material to reduce the solvent content of the organic material. By means of lowering the surrounding pressure around the organic material to reduce the solvent content of the organic material, the invention prevents overflow of the organic material during fabrication, thereby improving the manufacturing quality, shortening the manufacturing time, and reducing the manufacturing cost.

### BRIEF DESCRIPTION OF THE DRAWINGS

FIG. 1 is a fabrication flowchart of an organic material layer fabrication method in accordance with a first embodiment of the present invention.

FIG. 2 is a schematic drawing showing the fabrication of an organic material layer on a substrate in accordance with a second embodiment of the present invention.

FIG. 3 is a schematic top view of an organic layer, showing multiple organic material units formed on the substrate according to the second embodiment of the present invention.

FIG. 4 is a fabrication flowchart of an organic material layer fabrication method in accordance with a third embodiment of the present invention.

FIG. 5 is a schematic drawing showing the fabrication of an organic material layer on a substrate in accordance with a prior art fabrication method.

### DETAILED DESCRIPTION OF THE INVENTION

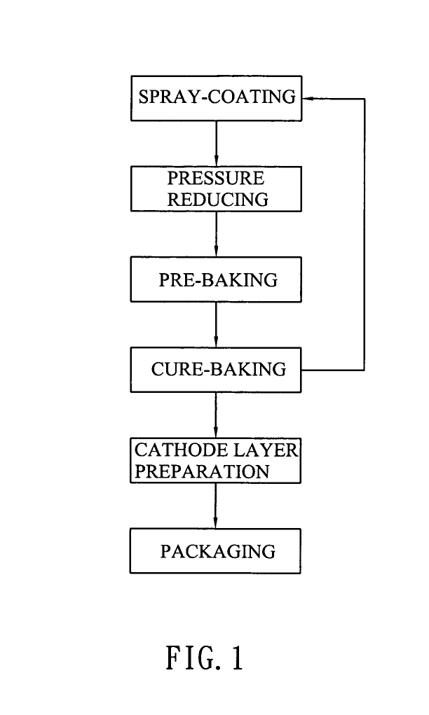

Referring to FIG. 1, an organic material layer fabrication method in accordance with a first embodiment of the present invention is employed for the fabrication of an OLED (Organic Light Emitting Diode). The organic material layer fabrication method includes the follow steps:

Step I: Coating. At first, a well-cleaned ITO (Indium-Tin-Oxide) substrate is put in an enclosed chamber, and then an organic material layer is formed on the surface of the ITO substrate (or on the surface of another organic material layer already formed on the ITO substrate) by employing a spray coating technique to coat the surface of the ITO substrate with a layer of an organic material. The organic material layer can be an EML (Emitting Material Layer), EIL (Electronic Inject Layer), ETL (Electron Transport Layer), HTL (Hole Transport Layer), or HIL (Hole Inject Layer). The ITO substrate can be used as an anode layer for the OLED.

Step II: Pressure reducing. Lower the pressure in the enclosed chamber. When the pressure in the chamber is lowered, the vaporization speed of the solvent contained in the organic material is relatively accelerated. According to this embodiment, the pressure in the enclosed chamber is lowered to the level below 1 atmosphere pressure. When the vapor pressure of the solvent contained in the organic material is relatively greater, the organic material becomes dry soon after the pressure is lowered, and the coating of another organic material layer can then proceed. If the organic material layer is not cured after the pressure has been lowered, the following steps may be performed.

Step III: Pre-baking. Remove the substrate to another chamber and then raise the temperature in the chamber to about 100° C. to further lower the solvent content of the organic material layer. This pre-baking step also smoothens the surface of the organic material layer.

Step IV: Cure-baking. Increase the temperature in the chamber above the pre-baking temperature to bake the ITO substrate and the organic material layer, reducing the solvent content to the lowest level and simultaneously curing the organic material layer. When the organic material is cured, as shown in FIG. 1, repeat steps I˜IV to form another organic material layer, till the desired laminate composition is finished.

Step V: Cathode layer preparation. Employ a coating technique to form a metal layer on the surface of the organic material layer for use as a cathode layer for the OLED.

Step VI: Packaging. Use a glass cover and an UV curable adhesive to wrap the cured organic material layer, finishing the fabrication of a single-piece OLED.

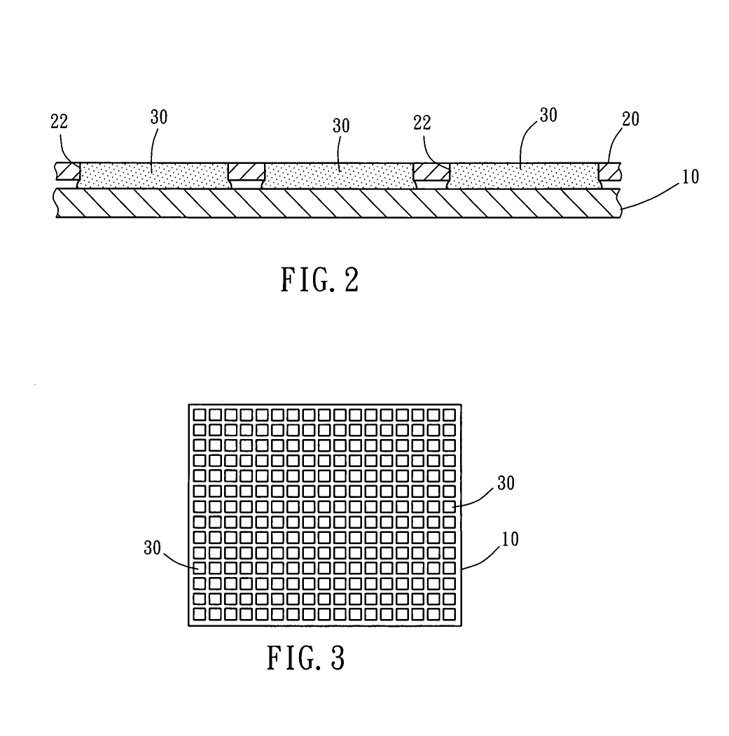

Referring to FIG. 2, an organic material layer fabrication method in accordance with a second embodiment of the present invention is for fabricating a batch of OLEDs. The organic material layer fabrication method includes the steps of:

Step I: Put a well-cleaned ITO substrate 10 in an enclosed chamber, and then, as shown in FIG. 2, put a mask 20 having predetermined openings 22 on the surface of the substrate 10.

Step II: Spray-coat an organic material on the mask 20 to fill up the openings 22, thereby forming multiple organic material units 30 on the surface of the substrate 10.

Step III: Lower the pressure in the enclosed chamber. When the pressure in the enclosed chamber is lowered, the vaporization speed of the solvent contained in the surface of the organic material units 30 is accelerated, and therefore the solvent content is rapidly reduced. According to this embodiment, when the pressure in the enclosed chamber is lowered to the level below 0.5 atmosphere, the solvent content is reduced from the original 90% to about 10% or lower.

Step VI: Move the pressure-reducing treated substrate 10 to another enclosed chamber and pre-bake the substrate 10 and the organic material units 30 to further lower the solvent content in the organic material units 30. According to this embodiment, the pre-baking temperature is about 50° C., and the pre-baking time is about 30 seconds. After this pre-baking process, the solvent content is reduced to below 1%.

Step V: Bake the substrate 10 with a higher temperature to cure the organic material layer. After the organic material layer is cured, repeat the aforesaid Steps II˜V to form another organic material layer till that the desired laminate composition is finished.

Step VI: Form a cathode layer on the surface of the organic material layer.

Step VII: Remove the mask and package the substrate 10, and then cut the package to separate the organic material units 30, forming a batch of OLEDs.

During the aforesaid fabrication method, either the single-piece OLED fabrication or the batch fabrication, the application of the pressure-reducing process after coating of the organic material on the ITO substrate rapidly lowers the solvent content of the organic material. Rapid reduction of solvent content, for example, in Step III of the aforesaid second embodiment of the present invention, greatly lowers the flowability of the organic material, thus eliminating material overflow. In case of a minor impact or vibration during transfer of the substrate from one to another enclosed chamber or upon removal of the mask from the surface of the substrate, the organic material will not be damaged.

Further rapid vaporization of the solvent content from the organic material causes the organic material to be dried and cured quickly. In case further pre-baking and cure-baking are necessary, the baking temperature can be relatively reduced, and the pre-baking or baking time can be shortened.

Therefore, the application of the present invention during the fabrication of the organic material layer eliminates material overflow, improves manufacturing quality, shortens the fabrication time, and reduces the manufacturing cost.

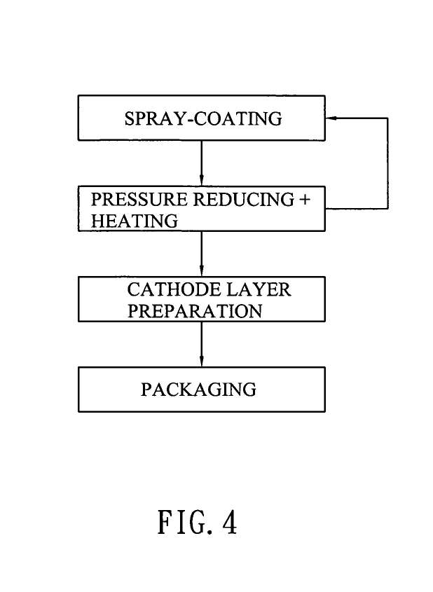

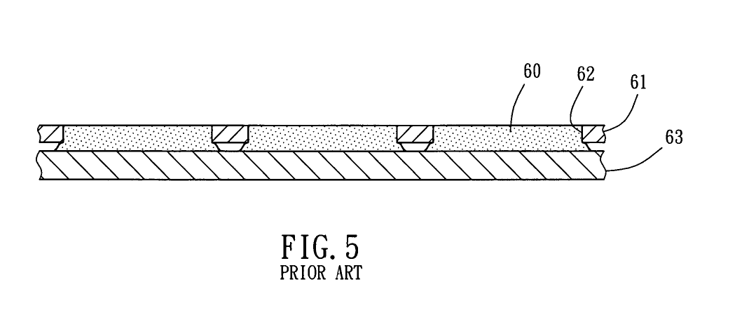

FIG. 4 is a fabrication flowchart of an organic material layer fabrication method in accordance with a third embodiment of the present invention. According to this embodiment of the organic material layer fabrication method, the pressure is lowered in the enclosed chamber and simultaneously the substrate and the organic material are heated after the organic material is spray-coated on the surface of the prepared substrate, thereby vaporizing the solvent content and curing the organic material in one step. Pre-baking or cure-baking may be employed to further cure the organic material. This embodiment achieves the same effects as the aforesaid first and second embodiments.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An organic material layer fabrication method, comprising the steps of:
a) coating an organic material that contains an organic solvent; and
b) lowering the pressure around said organic material to lower the solvent content of said organic material.

2. The organic material layer fabrication method as claimed in claim 1, wherein the pressure around said organic material is lowered to below 1 atmosphere in step b).

3. The organic material layer fabrication method as claimed in claim 1, wherein the pressure around said organic material is lowered to below 0.5 atmosphere in step b).

4. The organic material layer fabrication method as claimed in claim 1, further comprising the step of baking said organic material to a dry status after step b).

5. The organic material layer fabrication method as claimed in claim 4, wherein the temperature at which said organic material are baked is below 150° C.

6. The organic material layer fabrication method as claimed in claim 4, wherein the temperature at which said organic material are baked is below 100° C.

7. The organic material layer fabrication method as claimed in claim 1, wherein a heating procedure is further employed to heat said organic material in step b).

8. The organic material layer fabrication method as claimed in claim 1, wherein said organic material is adapted for forming one selected from the group consisting of electronic inject layer, electronic transport layer, emitting material layer, hole transport layer, and hole inject layer.

9. An organic material layer fabrication method, comprising the steps of:
a) preparing a substrate and putting a mask on said substrate, said mask having at least one opening;
b) covering a solvent-containing organic material on said mask so that said solvent-containing organic material fills up said at least one opening;
c) lowering the pressure around said solvent-containing organic material to lower the solvent content of said solvent-containing organic material; and
d) removing said mask from said substrate so that at least one organic material unit is formed on said substrate.

10. The organic material layer fabrication method as claimed in claim 9, wherein the pressure around said solvent-containing organic material is lowered to below 1 atmosphere in step c).

11. The organic material layer fabrication method as claimed in claim 9, wherein the pressure around said solvent-containing organic material is lowered to below 0.5 atmosphere in step c).

12. The organic material layer fabrication method as claimed in claim 9, further comprising the step of baking said solvent-containing organic material to a dry status after step c).

13. The organic material layer fabrication method as claimed in claim 12, wherein the temperature at which said solvent-containing organic material are baked is below 100° C.

14. The organic material layer fabrication method as claimed in claim 12, wherein the temperature at which said solvent-containing organic material are baked is below 50° C.

15. The organic material layer fabrication method as claimed in claim 9, wherein a heating procedure is further employed to heat said solvent-containing organic material in step c).

16. The organic material layer fabrication method as claimed in claim 9, wherein said organic material unit is adapted for forming one selected from the group consisting of electronic inject layer, electronic transport layer, emitting material layer, hole transport layer and hole inject layer.
